(19) United States
(12) Patent Application Publication
(10) Pub. No.: US 2008/0298188 A1
(43) Pub. Date: Dec. 4, 2008

(54) Device for and Method of Recording Information on a Record Carrier

(75) Inventors: Dirk Hamelinck, Beerzel (BE); Johannis Friso Rendert Blacquiere, Eindhoven (NL); Pope Ijtsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,148

(22) PCT Filed: Jul. 7, 2005
(86) PCT No.: PCT/IB05/52266

§ 371 Date: Jan. 16, 2007

(30) Foreign Application Priority Data
Jul. 21, 2004 (EP) 04103487.7

(51) Int. Cl. G11B 27/32

(52) U.S. Cl. 369/47.15; G9B/27.025

(57) ABSTRACT

A recording device for recording information at addressable locations on a removable record carrier for storing data. The device comprises monitoring means (31) for monitoring recording of the data by storing recorded data addresses in a memory. Further, the device comprises examining means (32) for retrieving the recorded data based on addresses read from the memory, and for checking the recorded data addresses for presence of special data. This allows for tracking of changes of the special data stored on the record carrier. The device is capable of generating additional data depending on the special data and of recording the additional data on the record carrier without reading all the special data.

The invention relates to a recording device for recording information at addressable locations on a removable record carrier for storing data, which device comprises recording means for recording marks on the record carrier representing the information.

The invention further relates to a method of storing additional data for use in recording information at addressable locations on a removable record carrier for storing data.

The invention further relates to a computer program product for storing additional data for use in recording information at addressable locations on a removable record carrier for storing data.

Recording media like optical discs (DVD+RW, Blu-Ray, etc.) are capable of storing large amount of data of different types. They can be used in different environments having specific requirements as for organization of data on a recording medium. Typically, data are organized into files in accordance with rules of a particular file system. Such file system has its own file system data, which include information about all kind of structures relating to (user) data stored on a recording medium. In particular, file system data may include volume structures representing the structures of logical and/or physical volumes, file structures representing the structures of files containing the data, directory structures describing grouping of files, and a space bitmap representing allocated or unallocated space for storing data on a recording medium. A recording medium may comprise addressable recording units for storing the data. At a level of a file system those units are referenced to with use of logical addresses defining a contiguous addressing (storage) space to be used for storing sequences of information blocks, such as files under control (according to rules) of the file system, for example UDF. Partitioning of a recording medium allocates a space on the medium for storing data under control (according to rules) of a file system.

At present, for example, DVD+RW discs are in use by Consumer Electronics (CE) devices and in the Personal Computer (PC) environment. In the CE environment DVD+RW discs are used mainly for recording digital video information according to a specific format like DVD Video Recording (DVD+VR). This means that there are defined specific allocation rules and set of files containing the video information itself and information about that video information such as title information, menu structures, etc. For example, in the DVD+VR format some (file system) pointers are located at fixed address positions; also, certain files start at fixed addresses. Next to that the (predefined) list of files has to be physically on a medium in a certain order.

The PC environment is based on a different philosophy. There are, in principle, no allocation requirements. Specific applications may require some files to be present in a certain directory and specific application will typically have their own data format to store information in files or to retrieve information from a file. This means that as long as there is free space available on a medium it is possible to add data files to that medium from all kinds of different applications. As an example, on a single disc there could be multi-media files, text files and executable files all mixed with each other.

Recently, more and more CE devices, like video players/recorders, have capability to seek through the file system information on the disc for files of a certain type that they can handle as well. Example of this are (mainly) JPEG files and also, already more and more, MP3 files. In the future possibly more types of multi-media files will be supported in the CE world. Next to that, also new standards on meta-data are created (such as e.g. MPV or HighMAT) designed to make it easier to move digital content between PCs and home electronics devices.

The published international patent application WO 2002/086729 discloses a device for recording data, capable of storing file system data of different file systems on one storage medium, so-called “bridge medium”. This facilitates sharing of the bridge medium between different environments, e.g. the CE environment and the PC environment. The device has recording means for recording the information in information blocks having logical addresses on an optical disc in a track at allocated physical addresses. The logical addresses constitute a contiguous storage space. The file system data of a first file system are mirrored in equivalents of a second file system. After addition (modification) of the data on the bridge medium (bridge disc), the file system data must be synchronized by means of so-called “bridge application”.

In the PC environment the most likely way of adding data to the bridge medium is by means of “drag-and-drop” technique. A user can then make the medium compatible with legacy players through the use of the bridge (compliance) application running on the PC. Basically, the bridge application writes second file system data, called “CE-bridge”, to the medium, using the suitable file system(s) and content pointers, such that other system can interpret these as content under its main file system. As a result, the CE-player will play the content that is referenced by this file system data, for which it has suitable content decoders.

During use of the medium in the PC “drag-and-drop” environment the content of the medium can be added, deleted or changed. These changes are tracked in the first file system; at a certain moment the CE-bridge needs to be updated with these changes. The bridge application has to determine whether new files were copied to the disc or existing files were changed. The normal way to determine whether any of these changes were made to the disc is to compare the first file system structures with the CE-bridge on the disc. With large discs with respect to capacity this could be quite a time consuming activity. Speed is a very important issue, especially when the application is started at the time a user wants to eject the disc.

This may lead to undesired effect as, in some cases, synchronization/update performed by the bridge application can take a substantial amount of time.

Generally, a problem exists when additional data such as the CE-bridge, which depends on data recorded on a record carrier, such as the first file system data, has to be recorded after addition/modification of the data. This requires time consuming processing of the complete data.

Therefore, it is an object of the invention to provide more efficient way of storing the additional data.

This object is achieved, according to a first aspect of the invention, by a device of the type described in the opening paragraph, comprising control means for controlling the recording, the control means comprising

monitoring means for monitoring recording of the data by storing recorded data addresses in a memory, the recorded data addresses corresponding to locations where the data are recorded,

examining means for retrieving the recorded data addresses from the memory, for reading data recorded at the recorded data addresses, and for checking the data recorded at the recorded data addresses for presence of special data,

storage means for storing additional data, the storage means being arranged for generating the additional data in dependence on the special data, and for

recording the additional data on the record carrier.

This provides a way to quickly determine which changes have taken place on the record carrier and to create/modify the additional data, accordingly.

In an embodiment of the device, the examining means are adapted for performing said retrieving the recorded data addresses from the memory after the control means receive an eject request to remove the record carrier from the device. Creating/modifying the additional data at the time when the record carrier is ejected from the device ensures that the additional data reflect all changes of data on the record carrier applied during its usage in the device.

In another embodiment of the device, the monitoring means are adapted for storing the recorded data addresses as a bitmap. This provides efficient way of storing the recorded data addresses.

It is advantageous, if the monitoring means are adapted for storing the recorded data addresses of locations where error correction code blocks are recorded, the data being arranged into said error correction code blocks. This allows for using smaller memory to store the recorded data addresses.

In an embodiment of the device, the examining means are adapted for checking the data recorded at the recorded data addresses for presence of first file system data as the special data, and the storage means are adapted for generating second file system data as the additional data in dependence on the first file system data, each file system data comprising corresponding file system entries with address references pointing to user data recorded on the record carrier. This provides an efficient way of updating the second file system data on the bridge medium.

In a further embodiment of the device, the examining means are adapted for comparing the recorded data addresses with predefined addresses of locations for recording the special data, and for performing said reading and/or said checking the data recorded at the recorded data addresses in dependence on said comparing. This improves a process of inspecting the special data, e.g. the first file system data.

According to a second aspect of the invention a method of storing additional data for use in recording information of the type described in the opening paragraph is provided, the method comprising:

monitoring recording of the data by storing recorded data addresses in a memory, the recorded data addresses corresponding to locations where the data are recorded;

retrieving the recorded data addresses from the memory;

reading data recorded at the recorded data addresses;

checking the data recorded at the recorded data addresses for presence of special data;

generating additional data in dependence on the special data;

recording the additional data on the record carrier.

According to a third aspect of the invention a computer program product for storing additional data for use in recording information of the type described in the opening paragraph is provided, which program is operative to cause a processor to perform the method as described in relation to the second aspect of the invention.

These and other aspects of the invention will be apparent from and elucidated further with reference to the embodiments described by way of example in the following description and with reference to the accompanying drawings, in which:

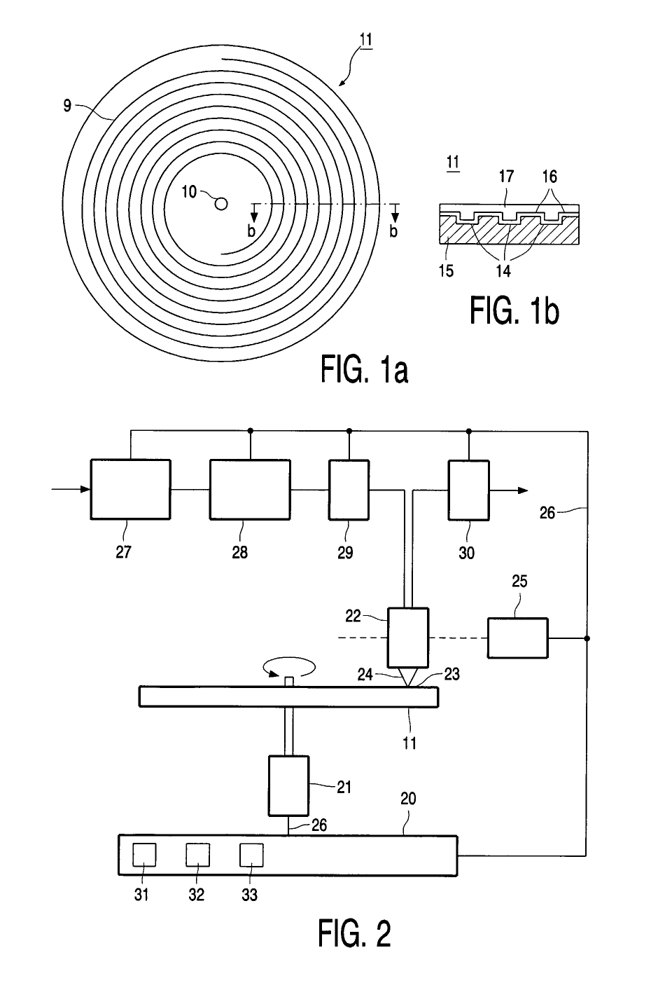

FIG. 1a shows a recording medium (top view),

FIG. 1b shows a recording medium (cross section),

FIG. 2 shows a recording device, in accordance with the invention,

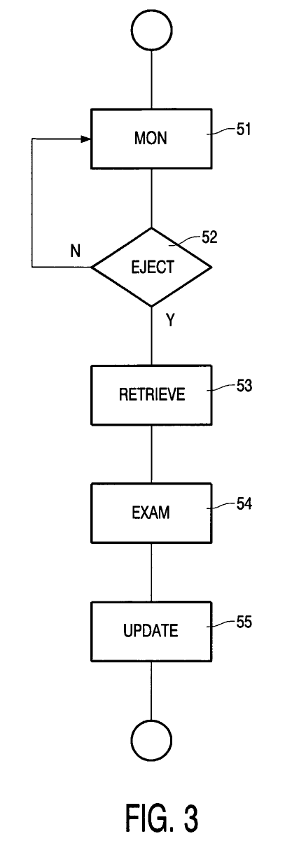

FIG. 3 shows an example of a method of storing additional data, in accordance with the invention.

Corresponding elements in different Figures have identical reference numerals.

FIG. 1a shows an example of a recording medium 11 having a form of disc with a track 9 and a central hole 10. The track 9, being the position of the series of (to be) recorded marks representing information (data), is arranged in accordance with a spiral pattern of turns constituting substantially parallel tracks on an information layer. The recording medium may be optically readable, called an optical disc, and has an information layer of a recordable type. Examples of a recordable disc are the CD-RW, and writable versions of DVD, such as DVD+RW, and the high density writable optical disc using blue lasers, called Blu-ray Disc (BD). The information is represented on the information layer by recording optically detectable marks along the track, e.g. crystalline or amorphous marks in phase change material. The track 9 on the recordable type of recording medium is indicated by a pre-embossed track structure provided during manufacture of the blank recording medium. The track structure is constituted, for example, by a pregroove 14, which enables a read/write head to follow the track during scanning. The track structure comprises position information, e.g. addresses, for indication the location of units of information, usually called information blocks or packets.

FIG. 1b is a cross-section taken along the line b-b of the recording medium 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

FIG. 2 shows a recording device for recording information on a recording medium 11 such as CD-RW, DVD+RW or BD, in accordance with the invention. The apparatus is provided with writing means for scanning the track on the recording medium, which means include a drive unit 21 for rotating the recording medium 11, a head 22, and a positioning unit 25 for coarsely positioning the head 22 in the radial direction on the track. The head 22 comprises an optical system of a known type for generating a radiation beam 24 guided through optical elements focused to a radiation spot 23 on a track of the information layer of the recording medium. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading, the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve information (data). Hence retrieving means for reading information include the drive unit 21, the head 22, the positioning unit 25 and the read processing unit 30. The device comprises write processing means for processing the input information to generate a write signal to drive the head 22, which means comprise an (optional) input unit 27, and modulator means comprising a formatter 28 and a modulator 29. During the writing operation, marks representing the information are formed on the record carrier. The marks are formed by means of the spot 23 generated on the recording layer via the beam 24 of electromagnetic radiation, usually from a laser diode. Digital data is stored on the record carrier according to a predefined data format. Writing and reading of information on/from optical disks and formatting, error correcting and channel coding rules are well-known in the art, e.g. from the CD and DVD system. The input unit 27 processes input data to units of information, which are passed to the formatter 28 for adding control data and formatting the data, e.g. by adding error correction codes (ECC) and/or interleaving. For computer applications units of information may be interfaced to the formatter 28 directly—in such case, as an option, the input unit 27 does not have to be present in the apparatus. The formatted data from the output of the formatter 28 is passed to the modulation unit 29, which comprises for example a channel coder, for generating a modulated signal, which drives the head 22. Further the modulation unit 29 comprises synchronizing means for including synchronizing patterns in the modulated signal. The formatted units presented to the input of the modulation unit 29 comprise address information and are written to corresponding addressable locations on the recording medium under the control of a control unit 20. The control unit 20, which controls the recording and retrieving of information, may be arranged for receiving commands from a user or from a host computer. The control unit 20 is connected via control lines 26, e.g. a system bus, to said input unit 27, formatter 28 and modulator 29, to the read processing unit 30, to the drive unit 21, and to the positioning unit 25. The control unit 20 comprises control circuitry, for example a microprocessor, a program memory and control gates, for performing the procedures and functions according to the invention as described below. The control unit 20 may also be implemented as a state machine in logic circuits.

The control unit 20 is arranged for controlling the recording by locating each block at a physical address in the track. The logical addresses constitute a contiguous user data storage space to be used for storing sequences of information blocks, such as files under control of a file management system, for example UDF. Such file system has its own file system data, which include information about all kind of structures relating to user data stored on a recording medium. In particular, file system data may include volume structures representing the structures of logical and/or physical volumes, file structures, such as file entries, representing the structures of files containing the user data, directory structures describing grouping of files, and a space bitmap representing allocated or unallocated space for storing data on a record carrier. It should be pointed out that file entries may also contain references to other file entries.

In an embodiment the device is a storage system only, e.g. an optical disc drive for use in a computer. The control unit 20 is arranged to communicate with a processing unit in the host computer via a standardized interface (not shown). File system data are generated by the processing unit and recorded on the record carrier under control of the control unit 20. Digital data is interfaced to the formatter 28 and from the read processing unit 30 directly. In this case, the interface acts as an input unit and an output unit; as an option, the input unit 27 does not have to be present in the device.

In an embodiment the device is arranged as a stand alone unit, for example a video recording apparatus for consumer use. The control unit 20, or an additional host control unit included in the device, is arranged to be controlled directly by the user, and to perform the functions of the file system(s). The device includes application data processing, e.g. audio and/or video processing circuits. User information is presented on the input unit 27, which may comprise compression means for input signals such as analog audio and/or video, or digital uncompressed audio/video. The read processing unit 30 may comprise suitable audio and/or video decoding units.

The control unit 20 includes the following cooperating units: a monitoring unit 31, an examining unit 32, and a storage unit 33, which units are for example implemented in firmware.

A read device has the same elements as the recording device, except the specific recording elements, e.g. the read device does not have the input unit 27, the formatter 28, the modulator 29, the monitoring unit 31, the examining unit 32 and the storage unit 33.

The monitoring unit 31 is for monitoring recording of data, for example user data or/and file system data; it keeps track of changes of files that are made on the record carrier. This is done by listing addresses of locations, where data is written to, after the record carrier has been inserted in the device. Listing the recorded data addresses is done via block addresses of the blocks where data have been written. The monitoring unit 31 stores the recorded data addresses in a memory. This memory is a part of the monitoring unit 31 itself, or a part of the control unit 20. Alternatively, the memory is a part of a separate memory unit (not shown in FIG. 2).

In an embodiment, the monitoring unit 31 is adapted for storing the recorded data addresses in a bitmap, which is big enough to contain all accessible blocks on the record carrier.

Information blocks can be arranged in bigger units called error correction code ECC blocks. For example, one information block, also called a sector, can contain 2 kB (2048 bytes) of data, and an ECC block can represent 16 sectors (32 kB of data), as specified by the DVD+RW recording standard.

In an embodiment, the monitoring unit 31 is adapted for tracking the changes based on ECC blocks. In this case the memory is for containing addresses of locations where these ECC blocks are recorded.

The examining unit 32 is for retrieving the recorded data addresses form the memory, for reading data recorded at the recorded data addresses, and for checking these data for presence of special data. In a practical embodiment, the special data are the first file system data and in particular, the first file system file entries.

In an embodiment, the examining unit 32 is adapted to perform said retrieving the recorded data addresses form the memory in response to a request to eject the record carrier from the device. Such request is received by the control unit 20 directly from the user or via the interface to the processing unit in the host computer.

In an embodiment, the examining unit 32 is adapted for comparing the recorded data addresses with predefined addresses of locations for recording the special data, and for performing said reading and/or said checking the data recorded at the recorded data addresses in dependence on said comparing. This is done by using knowledge about structures of the special data, for example the first file system data and in particular the first file system file entries. As an option, based on the result of comparing the recorded data addresses with the predefined addresses, the examining unit 32 is capable of reading data only from selected recorded data addresses—the most likely locations for the special data—and/or use only these data when checking for presence of the special data.

For example, in an embodiment, the examining unit 32 is capable of comparing the recorded data addresses with predefined locations for storing the first file system file entries, which locations are either fixed or defined by other elements of the first file system data.

The storage unit 33 is for storing additional data. First the additional data are generated by the storage unit 33 in dependence on the special data; then, the additional data are recorded on the record carrier.

In a practical embodiment, the storage unit 33 is adapted to generate second file system data as the additional data in dependence of the first file system data as the special data. For example, second file system file entries are generated in dependence of the first file system entries as explained above with reference to the CE-bridge.

FIG. 3 shows an example of a method performed together by the monitoring unit 31, the examination unit 32 and the storage unit 33. The recording of data on the record carrier is monitored by storing addresses of locations, where data is written, in the memory in a step MON 51. In a next step EJECT 52 it is checked whether the eject request to remove the record carrier from the device has been issued. If so, the data recorded in the step MON 51 are retrieved in a step RETRIEVE 53, using the addresses from the memory. Further, in a step EXAM 54, the data are examined for presence of the special data and then the additional data are generated in dependence on the special data and recorded in a step UPDATE 55.

Embodiments of the method correspond to functionalities of the monitoring unit 31, the examination unit 32 and/or the storage unit 33 as described with reference to embodiments of the device.

It is noted that the function of the monitoring unit 31, the examination unit 32 and/or the storage unit 33 can be performed as (a part of) a process of storing the additional data in dependence on the special data in a separate device, for example as a computer program, an application, in a host computer controlling a disc drive.

In a practical embodiment, after an eject request is submitted to the drive there is an interaction started between the application and the drive. In this interaction the drive can send/give the bitmap with the changed locations (based on sectors or ECC blocks) on the disc to the application. The application can use this bitmap to quickly identify the locations on disc where new data is written. As a next step the application can check those locations to quickly find new or changed file entries. With information from the new or updated file entries the application can update the CE-bridge.

An embodiment of a computer program product according to the invention is operative to cause the control unit 20 or a processor in a computer to perform methods and functions as described in reference to embodiments of the recording device presented above.

An example of a process of recording additional data depending on special data already present on a record carrier, in accordance with the invention, is given below. In this example the record carrier is the CE-bridge disc; the special data are the first file system data and the additional data are the second file system data, the CE-bridge.

The disc is put in the PC and then a new file is copied to the disc. This means that the file data is copied to the disc and a new file entry is created in the first file system structures. At eject time the application has to decide whether the CE-bridge has to be updated. The ‘normal’, prior art, way to do this would be to read the entire first file system structures, create the CE-bridge and write it to the disc. An alternative way would be to also read the CE-bridge on the disc and decide whether it has to be updated or not and only change those parts of the CE-bridge that need to be updated. As stated in the introductory part, this entire process, i.e. reading all first file system structures, reading the CE-bridge and comparing the two, could take quite a long time if there are a lot of files and therefore file entries on the disc, already.

In the process below the quicker solution in accordance with the invention is explained:

the task of the application is to make sure that the CE-bridge is updated correctly to reflect the copying of the new file to the disc. In the drive a bitmap with all changed ECC blocks is kept. The application requests this bitmap from the drive via e.g. a special mode page command

as there is only one file added to the disc the bitmap indicates only a few changed locations. Locations that are typically changed are the locations where the file data itself is stored on disc together with the locations where the directory information and the file entry that point towards the file data are stored. The application can request the drive for the data from all these locations and search that data to look for the file entries. An optimization would be that the application uses some file system knowledge to determine the most likely locations for the file entries

via the file entry the application can determine the position of the file in the file system tree with respect to the root directory. That information can be used to update the CE-bridge in such a way that the added file is added to the CE-bridge at the similar location in the second file system tree

next, the application updates the CE-bridge properly to reflect the change of the disc due to the copying of this single file.

The method according to the invention is particularly useful if there are not so many changes to the disc and the disc contained already a relative large number of files. These two requirements guarantee that the file entry of the added file can be found fast and that a lot of time is saved because the large file system structure of all files already on the disc doesn't have to be searched through. File entries can be found relatively easy because they contain a special signature that is easy to recognize. In a file entry the locations of the file data itself can be found. Naturally the application doesn't have to search the data from those locations for any other file entries. As such these locations can be considered already accounted for when the application checks the bitmap.

Whilst the invention has been described with reference to preferred embodiments thereof, it is to be understood that these are not limitative examples. Thus, various modifications may become apparent to those skilled in the art, without departing from the scope of the invention, as defined by the claims and the embodiments. Further, the invention lies in each and every novel feature or combination of features described above. Also, for the storage medium an optical disc has been described, but other media, such as a magneto-optical disc or magnetic tape, can be used. It is noted, that the invention may be implemented by means of a general purpose processor executing a computer program or by dedicated hardware or by a combination of both, and that in this document the word “comprising” does not exclude the presence of other elements or steps than those listed and the word “a” or “an” preceding an element does not exclude the presence of a plurality of such elements, that any reference signs do not limit the scope of the claims, that “means” may be represented by a single item or a plurality and that several “means” may be represented by the same item of hardware.

1. A recording device for recording information at addressable locations on a removable record carrier for storing data, which device comprises
recording means (22) for recording marks on the record carrier representing the information, and
control means (20) for controlling the recording, the control means comprising
monitoring means (31) for monitoring recording of the data by storing recorded data addresses in a memory, the recorded data addresses corresponding to locations where the data are recorded,
examining means (32) for retrieving the recorded data addresses from the memory, for reading data recorded at the recorded data addresses, and for checking the data recorded at the recorded data addresses for presence of special data,
storage means (33) for storing additional data, the storage means being arranged for
generating the additional data in dependence on the special data, and for
recording the additional data on the record carrier.

2. A recording device as claimed in claim 1, wherein the examining means (32) are adapted for performing said retrieving the recorded data addresses from the memory after the control means (20) receive an eject request to remove the record carrier from the device.

3. A recording device as claimed in claim 1, wherein the monitoring means (31) are adapted for storing the recorded data addresses as a bitmap.

4. A recording device as claimed in claim 1, the data being arranged into error correction code blocks, wherein the monitoring means (31) are adapted for storing the recorded data addresses of locations where said error correction code blocks are recorded.

5. A recording device as claimed in claim 1, wherein the examining means (32) are adapted for checking for presence of first file system data as the special data, and the storage means (33) are adapted for generating second file system data as the additional data in dependence on the first file system data, each file system data comprising corresponding file system entries with address references pointing to user data recorded on the record carrier.

6. A recording device as claimed in claim 1, wherein the examining means (32) are adapted for comparing the recorded data addresses with predefined addresses of locations for recording the special data, and for performing said reading and/or said checking the data recorded at the recorded data addresses in dependence on said comparing.

7. A method of storing additional data for use in recording information at addressable locations on a removable record carrier for storing data, the method comprising:
monitoring recording of the data by storing recorded data addresses in a memory, the recorded data addresses corresponding to locations where the data are recorded;
retrieving the recorded data addresses from the memory;
reading data recorded at the recorded data addresses;
checking the data recorded at the recorded data addresses for presence of special data;
generating additional data in dependence on the special data;
recording the additional data on the record carrier.

8. A method as claimed in claim 7, wherein said retrieving the recorded data addresses from the memory is performed after an eject request to remove the record carrier from a recording device.

9. A method as claimed in claim 7, wherein the recorded data addresses are stored as a bitmap.

10. A method as claimed in claim 7, wherein the data are arranged into error correction code blocks, and the recorded data addresses are addresses of locations where said error correction code blocks are recorded.

11. A method as claimed in claim 7, the method comprising checking the data recorded at the recorded data addresses for presence of first file system data as the special data, and wherein said generating the additional data comprises generating second file system data as the additional data in dependence on the first file system data, each file system data comprising corresponding file system entries with address references pointing to user data recorded on the record carrier.

12. A method as claimed in claim 7, comprising comparing the recorded data addresses with predefined addresses of locations for recording the special data, and wherein said reading and/or said checking the data recorded at the recorded data addresses is performed in dependence on said comparing.

13. A computer program product for use in recording information at addressable locations on a removable record carrier for storing data, which program is operative to cause a processor to perform the method as claimed in claim 7.
